(19) United States
(12) Patent Application Publication
(10) Pub. No.: US 2013/0114318 A1
(43) Pub. Date: May 9, 2013

(54) SOLID-STATE INDUCTIVE CONVERTER

(71) Applicant: Giacomo Carlucci, Lavello (IT)

(72) Inventor: Giacomo Carlucci, Lavello (IT)

(73) Assignee: Giacomo CARLUCCI, Lavello (PZ) (IT)

(21) Appl. No.: 13/808,320

(22) PCT Filed: Jul. 6, 2009
(86) PCT No.: PCT/IT2009/000296

§ 371 Date: Jan. 4, 2013

(51) Int. Cl. H02M 7/537

(52) U.S. Cl. CPC H02M 7/537
USPC 363/131

(57) ABSTRACT

A converter configured to transform DC into AC. Includes a first and second transistor with connected bases and emitters, and a coil or inductor having a first end that is connected to the bases, a second end that is free, and a common central zero, which is connected to the emitters and divides the inductor into two equal portions, a first portion from the end to a central zero and a second portion from the latter to the end. The circuit is supplied by a direct current applied to the collectors and envisages at least one output between said second end and the collector of one of the two transistors configured to supply a respective load and behaves substantially as a capacitor or electroluminescent cable/panel. Transistors work alternatively by following the cycles of charging and discharging of the load and obtain a supply current having a substantially perfect sinusoidal waveform.

The present invention basically relates to the sector of devices for electrical supply of loads and/or apparatuses, such as, for example, electroluminescent cables and/or panels, neon lamps, etc.

The invention stems from the need to supply a load, such as, for example, an electroluminescent cable or panel, with an alternating current having a substantially perfect sinusoidal waveform. In fact, a practically perfect sinusoid improves the efficiency of the cable both in terms of light intensity and in terms of service life.

Currently, to supply electroluminescent cables a normal inverter is used, but the efficiency in terms of effective brightness that can be obtained from the cable and in terms of energy consumption is altogether unsatisfactory. Likewise, with currently available inverters it is possible to supply only electroluminescent cables of very limited length, so much so that said cables are practically unusable for lighting purposes.

It is well known that an inverter is substantially an electronic device that is able to convert direct current into alternating current—possibly at a different voltage —or else an alternating current into an alternating current having a frequency different from the original one.

The general applications of currently available inverters are multiple:
in no-break power supplies, they convert the voltage supplied by the battery into alternating current;
in industry, they are used for regulating the rate of electric motors;
in the transmission of electrical energy, they convert the energy into direct current transferred into some long-distance electric power lines for being introduced into the a.c. mains supply.

The simplest type of inverter consists in an oscillator that drives a transistor, which by opening and closing a circuit generates a square wave. The wave is then applied to a transformer, which supplies at output the required voltage, to some extent rounding off the square wave. Frequently, instead of the common transistor, more efficient devices such as MOSFETs, thyristors, or IGBTs are used.

The square waveform generated by these devices presents the problem of being rich in higher-order harmonics, whilst the sinusoidal wave of the electrical network is devoid of higher-order harmonics. This leads to a lower efficiency of the equipment supplied, higher levels of both sound and electrical noise, and serious problems of electromagnetic compatibility.

More complex inverters use different approaches for producing at output a waveform that is as sinusoidal as possible. An electronic circuit produces a step-wise voltage by means of pulse-amplitude modulation (PAM) that is as close as possible to a sinusoid. The signal, referred to as modified sinusoid, is leveled by capacitors and inductors set at input to and at output from the transformer for suppressing the harmonics. The best and costliest inverters base their operation on pulse-width modulation (PWM). The system can be a feedback system so as to supply a stable voltage at output as the input voltage varies. For both types of modulation, the quality of the signal is determined by the number of bits used. It ranges from a minimum of 3 bits to a maximum of 12 bits, which is able to describe the sinusoid with excellent approximation.

In asynchronous motors and even more justifiably in synchronous motors, the speed of rotation is directly linked to the frequency of the supply voltage. Wherever it is necessary in industry to vary the speed of a motor, alternating-current/alternating-current (AC/AC) inverters are used.

In these systems, the input voltage is first converted into direct current by a rectifier and leveled by capacitors, then applied to the inverter section.

The purpose of this double operation is simply to vary the frequency as desired within a pre-set interval, and the presence of a transformer is not necessary since it is not necessary to vary the value of the voltage at output, which remains equal to the input voltage value.

The output frequency is determined in the simplest cases by an analog signal supplied to the inverter, for example by a potentiometer, or else by a digital signal sent by a PLC.

Photovoltaic inverters for introduction of electrical energy into the mains network, are a particular type of inverter, designed expressly for converting the electrical energy in the form of direct current produced by a photovoltaic module into alternating current to be introduced directly into the mains network. These machines extend the basic function of a generic inverter with extremely sophisticated and advanced functions, by means of the use of particular software and hardware control systems that enable extraction from solar panels of the maximum power available in any weather condition. This function goes by the name of MPPT (Maximum Power Point Tracker). Photovoltaic modules, in fact, present a V/I characteristic curve such that there exists an optimal working point, referred to precisely as maximum-power point, where it is possible to extract all the power available. This point of the characteristic varies continuously as a function of the level of solar radiation that strikes the surface of the cells. It is evident that an inverter that is able to remain “locked” to this point will always obtain the maximum power available in any condition. There are a wide range of techniques to achieve the MPPT function, which differ as regards their dynamic performance (settling time) and accuracy. Even though the precision of the MPPT is extremely important, the settling time is, in some cases, even more important. Whereas all manufacturers of inverters manage to obtain high precision on the MPPT (typically between 99 and 99.6% of the maximum available), only a few manage to unite precision to speed. It is in fact on days with variable cloudiness that there occur extensive and sudden jumps of solar power. It is very common to detect variations of between 100 W/m² and 1000-1200 W/m² in less than 2 seconds. In these conditions, which are very frequent, an inverter with settling times of less than 5 seconds manages to produce up to 15%-20% of energy more than a slow inverter. Some photovoltaic inverters are provided with modular power stages, and some are even provided with one MPPT for each power stage. In this way, manufacturers leave to system engineering the freedom to configure a master/slave operation or an operation with independent MPPTs. In general, the use of separate MPPTs causes a few percentage points of average electrical efficiency of the machine to be lost since the latter is forced to function at full regime even with poor irradiation.

However, not infrequently the surface of the solar panels cannot be exposed to the sun uniformly over the entire range because it is set on two different leaves of the roof, or else the modules cannot be distributed on strings of equal length. In this case the use of just one MPPT would lead the inverter to work outside the maximum-power point, and consequently the production of energy thereof would be adversely affected.

Another important characteristic of a photovoltaic inverter is the mains-network interface. This function, which is generally integrated in the machine, must respond to the requisites imposed by the standards of the different boards responsible for supplying electrical energy. In Italy, ENEL has issued the DK5940 standard, currently at its 2.2 edition. This standard envisages a series of measurements of safety such as to prevent introduction of energy into the mains power supply in the case where the parameters of the latter are outside the limits of acceptability.

When transforming direct current into alternating current, currently known inverter circuits do not achieve an absolutely perfect sinusoidal waveform of the output alternating current. This is due principally to the presence of various passive components within the circuit itself, which paradoxically complicate the work, altering the quality of the end result.

Another important limitation of currently known inverters is that of not being able to supply an electroluminescent cable of large dimensions and/or considerable length. There is not available on the market a specific inverter that is able to meet the needs of the electroluminescent cable.

It should be noted that the two elements (inverter and cable) do not manage to interact properly; in fact, the power is supplied by the inverter irrespective of the technical characteristics of the electroluminescent cable connected thereto.

If compared to similar circuits, the device according to the present invention goes against what has currently been thought or believed up to now: the invention, in fact, can be defined substantially as a solid-state inductive converter that surprisingly optimises the performance necessary for establishing a balance with the cable.

Furthermore, as will be seen better from what follows, as compared to the devices currently present on the market, the device according to the present invention guarantees a better quality of light, thanks to the practically perfect sinusoidal form of the output signal that supplies the cable, and does not have any limitation of supply of direct current or any limitation of voltage and power. In all this, the inventive idea underlying the invention remains always the same, whilst, logically the size of the solid-state inductive converter changes as a function of the power supplied.

The circuit that constitutes the device according to the invention goes against everything that can be found in the literature, and indeed, according to what has up to now been formulated regarding the working principle of inverters, it should not even function.

A first purpose of the invention is to supply an electroluminescent cable of any diameter and any length with an alternating current, characterized by a practically perfect sinusoidal waveform.

A second purpose of the invention, is to supply an electroluminescent panel of any size with an alternating current, characterized by a practically perfect sinusoidal waveform.

The above and other purposes will be better understood from the ensuing detailed description and with reference to the annexed figures, which illustrate some preferred embodiments and variants thereof purely by way of non-limiting example.

In the drawings:

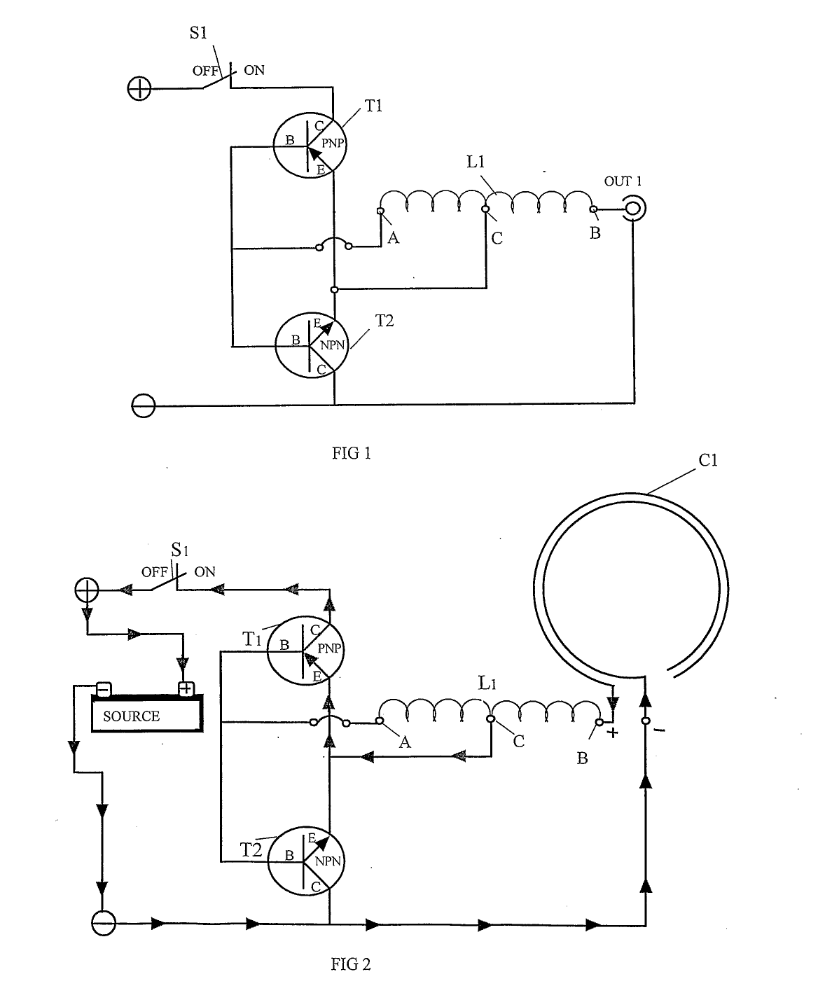

FIG. 1 shows the circuit of a first embodiment of the converter forming the subject of the invention comprising a first transistor, a second transistor, and an inductor, where the output for the load is located between one end of the inductor and the collector of the second transistor;

FIG. 2 shows the circuit of FIG. 1 upon closing of the switch, where a first transistor is active and a second transistor is inhibited;

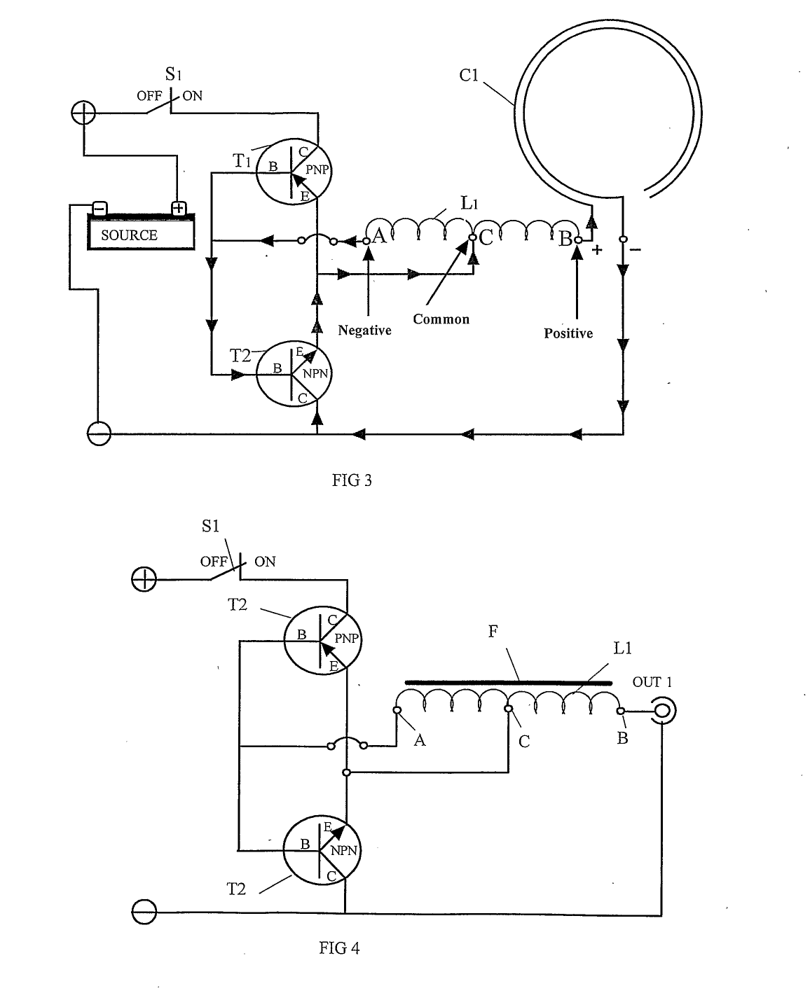

FIG. 3 shows the circuit of FIG. 1, where the first transistor is inhibited and the second transistor is active;

FIG. 4 shows a first variant of the circuit of FIG. 1, where the inductor is wound on a core of ferromagnetic material or ferrite;

FIG. 5 shows the circuit of FIG. 4, where, as an alternative to a switch, two pushbuttons are provided;

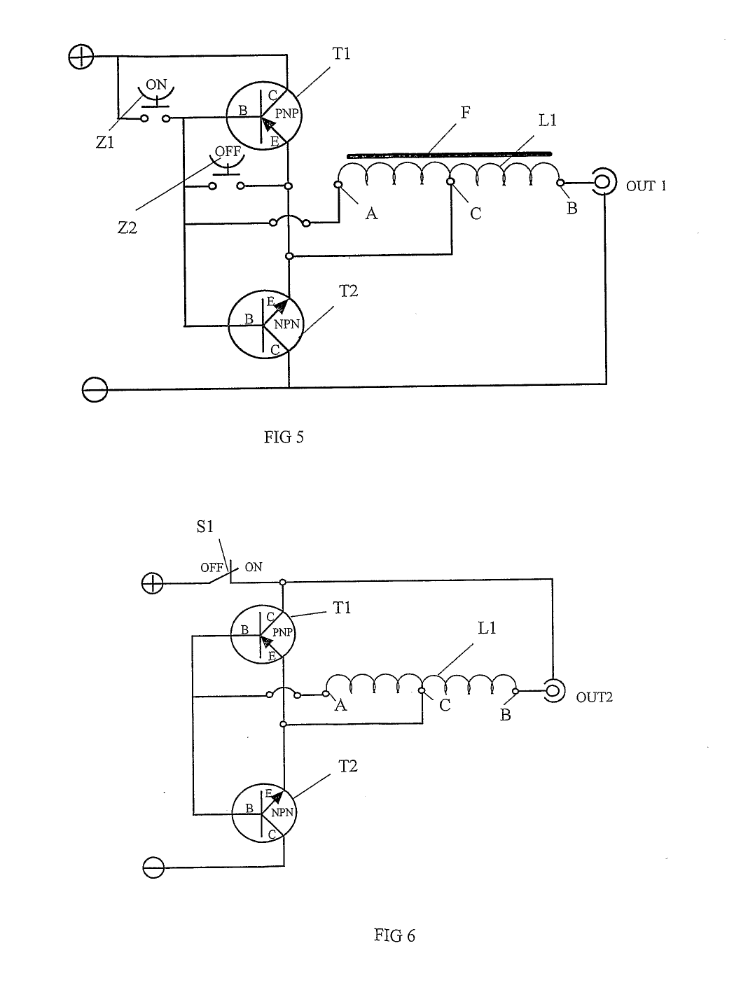

FIG. 6 shows the circuit of a second embodiment of the invention, where the output for the load is located between one end of the inductor and the collector of the first transistor;

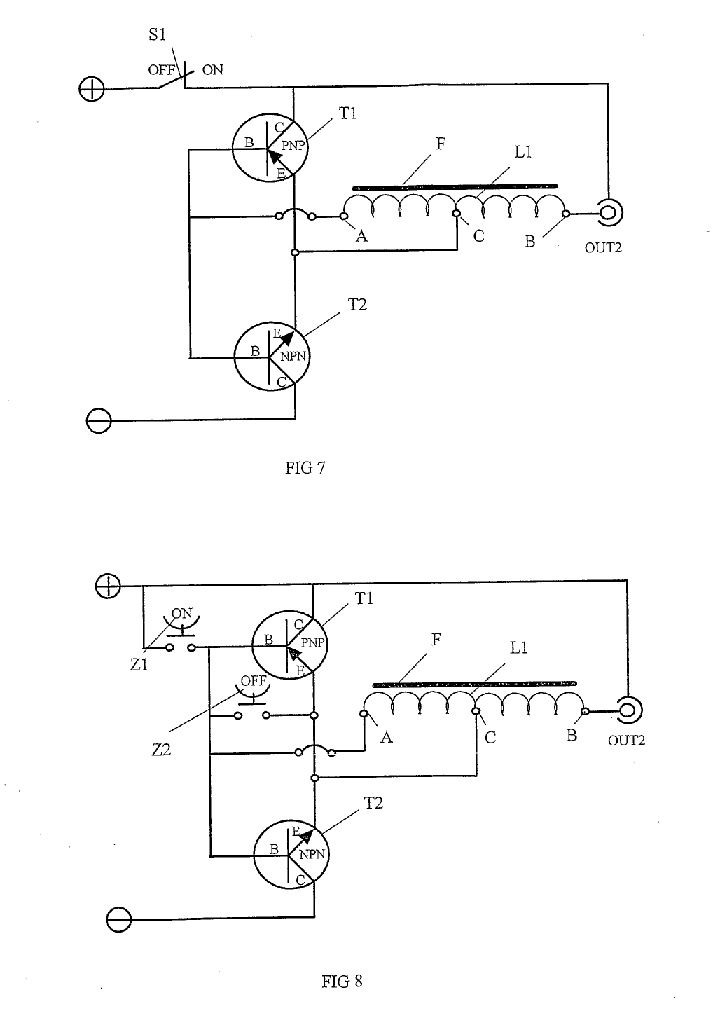

FIG. 7, like FIG. 4, shows a variant of the circuit of FIG. 4;

FIG. 8, like FIG. 5, shows the circuit of FIG. 7, where as an alternative to a switch two pushbuttons are provided;

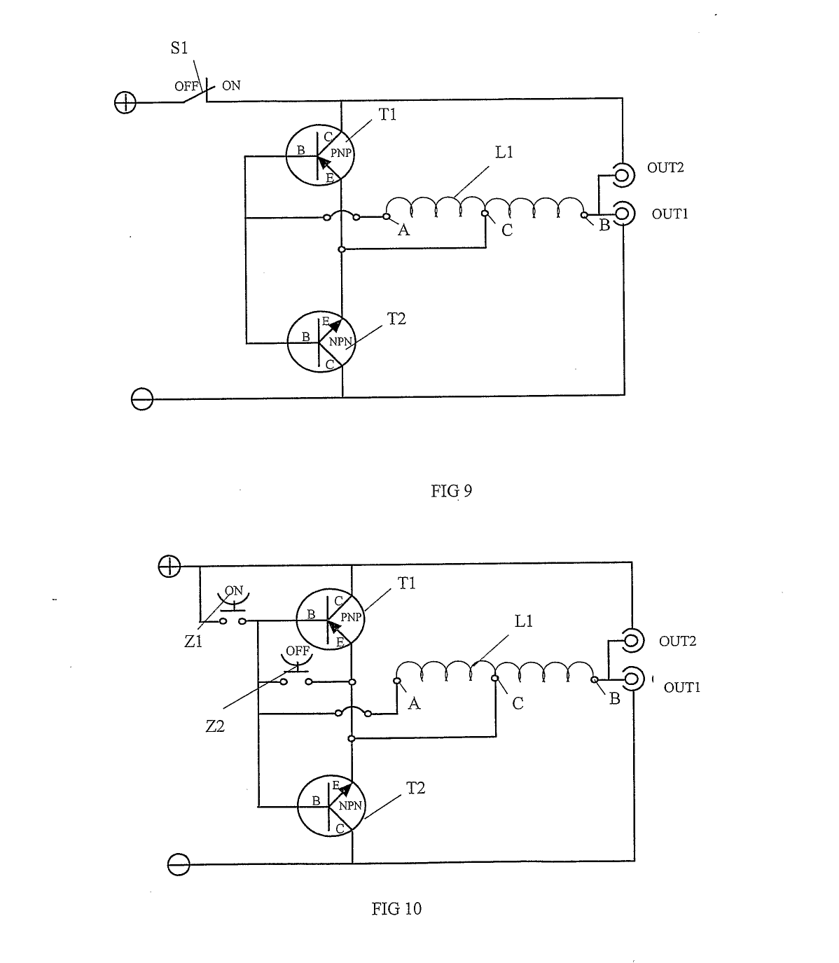

FIG. 9 shows the circuit of a third embodiment of the invention, where two outputs are provided for a corresponding load, a first output located between one end of the inductor and the collector of the first transistor, and a second output between the same end of the inductor and the collector of the second transistor;

FIGS. 10-12 each show a variant of the circuit of FIG. 9;

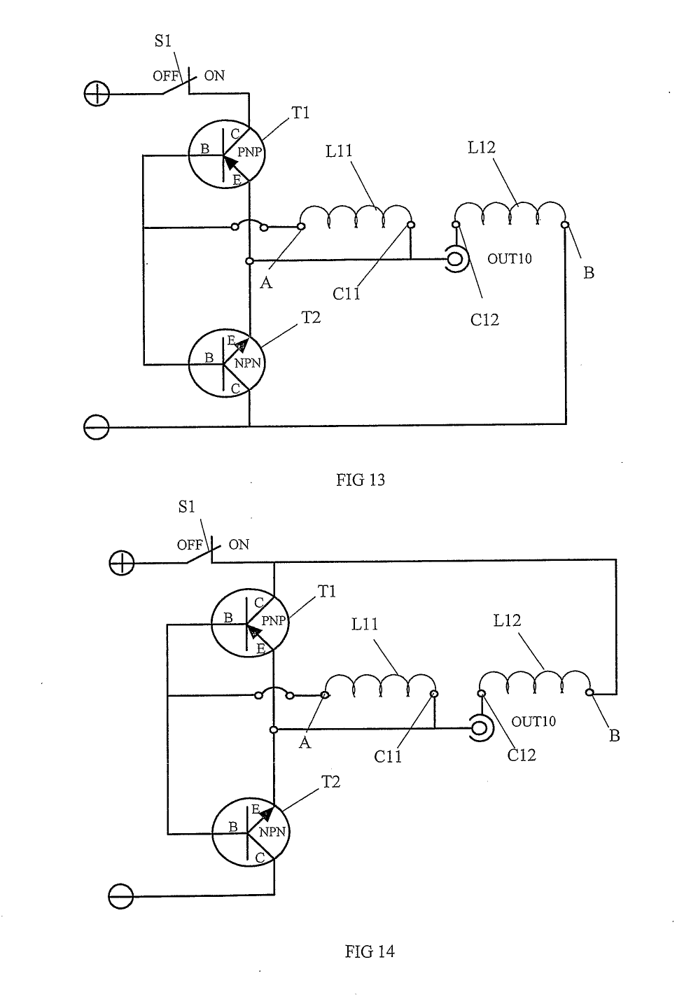

FIG. 13 shows a fourth embodiment of the circuit of FIG. 1, which comprises two inductors, which are the same as one another, and one output, which is taken between said two inductors and in which one end of the second inductor is connected to the collector of the second transistor;

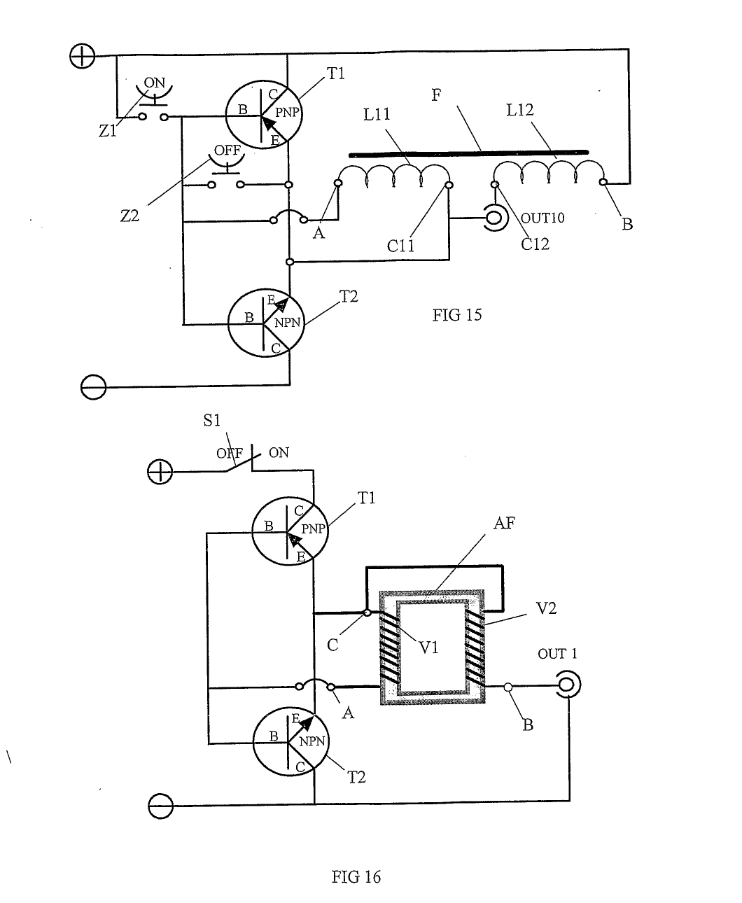

FIGS. 14 and 15 show, respectively, a fifth embodiment that comprises two inductors that are the same as one another, and one output, which is taken between said two inductors and in which one end of the second inductor is connected to the collector of the second transistor, and a variant thereof;

FIG. 16 shows the circuit of a sixth embodiment, which, unlike the circuit of the third embodiment of FIG. 9, envisages that the inductor is wound on a ring of ferromagnetic material or ferrite;

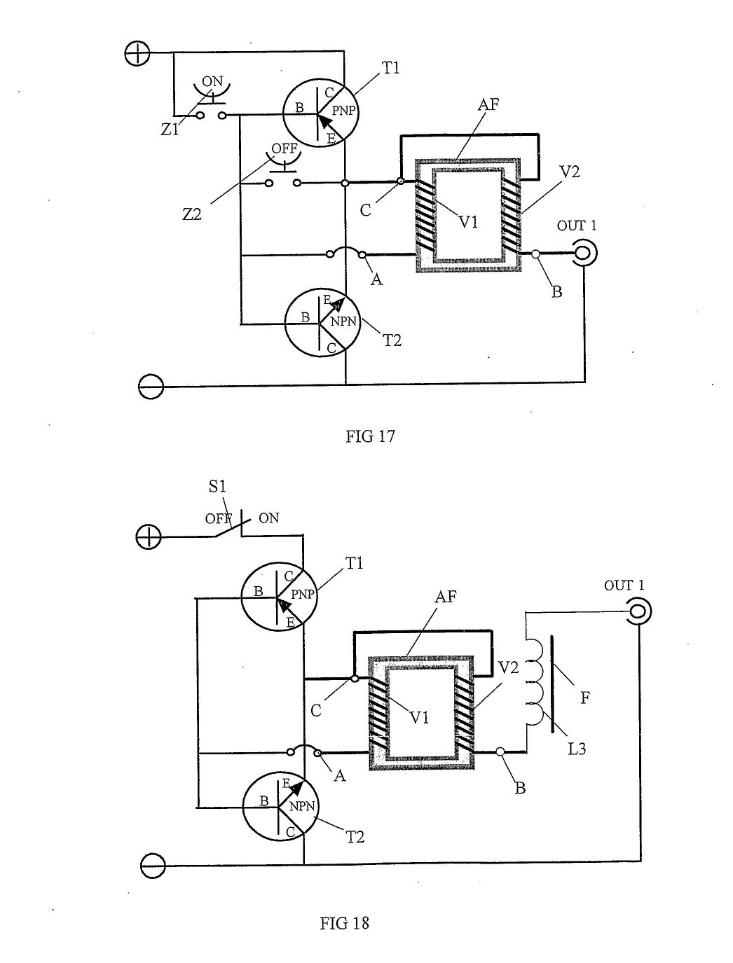

FIGS. 17 to 20 each show a variant of the circuit of FIG. 16;

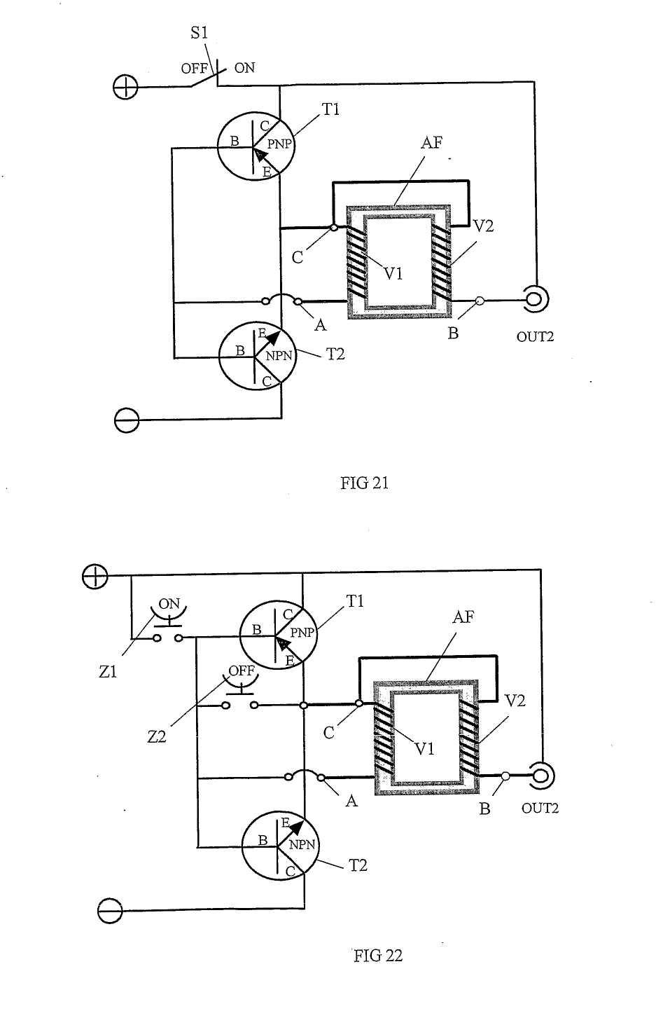

FIG. 21 shows the circuit in a seventh embodiment;

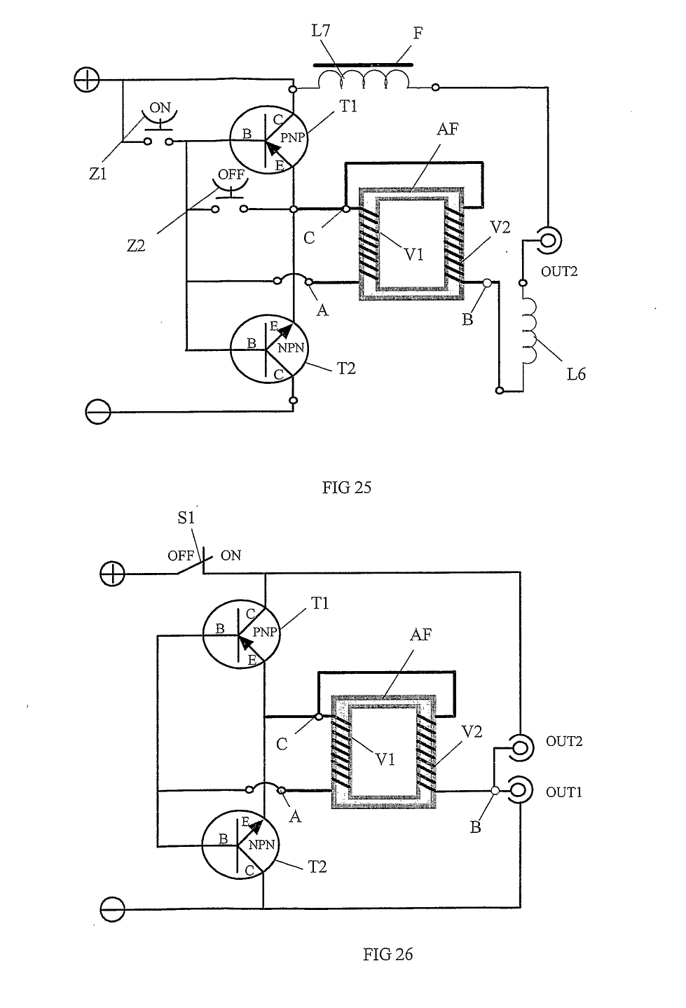

FIGS. 22 to 25 each show a variant of the circuit of FIG. 21;

FIG. 26 shows the circuit of an eighth embodiment; and

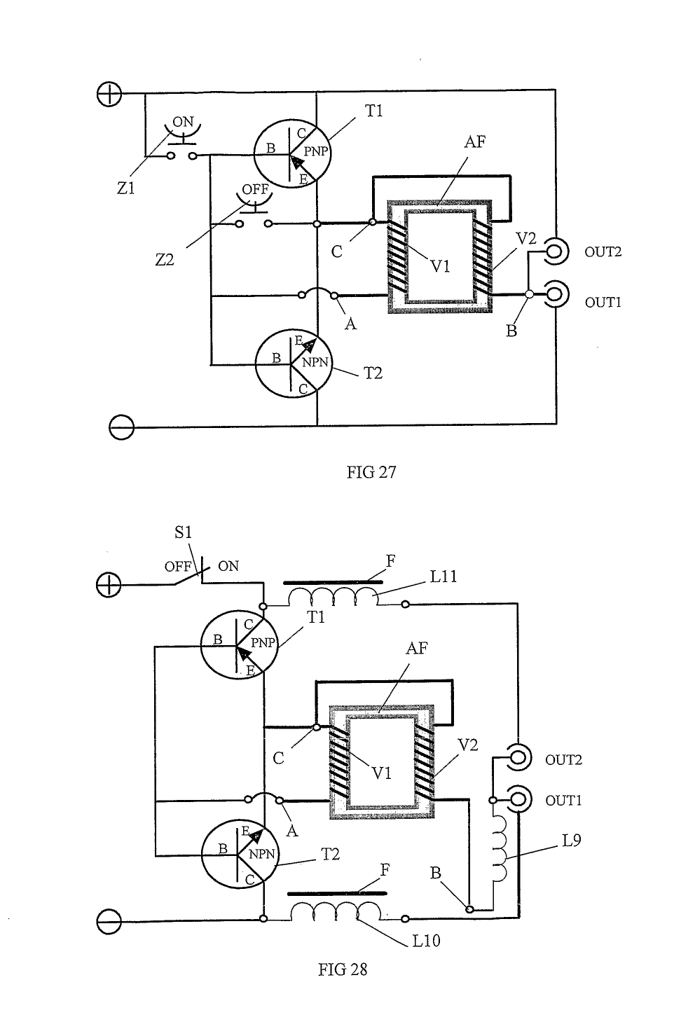

FIGS. 27 to 29 each show a variant of the circuit of FIG. 26.

With particular reference to FIGS. 1 to 3, in the first embodiment described, the basic circuit of the converter comprises:
a first transistor T1 of a PNP (or else NPN) type;
a second transistor T2 of an NPN (or else PNP) type, having the base and the emitter connected, respectively, to the base and to the emitter of the first transistor T1; and
a coil or inductor L1 having a first end A that is to be connected to the bases of said two transistors T1 and T2, a second end B that is free, and a common central zero C, which divides said inductor into two equal portions and is to be connected to the emitters of the transistors T1 and T2;
   wherein said circuit is supplied by a direct current applied to the collectors of the two transistors T1 and T2 and envisages at least one output, between said second end B and the collector of one transistor T1 or T2, for connecting a respective load C1 that is able to behave substantially as a capacitor, such as for example an electroluminescent cable or panel.

In the example described, the circuit envisages an output OUT1, which is taken between the end B of the inductor L1 and the collector of the second transistor T2.

The two portions of the inductor L1, i.e. , the portion from the end A to the central zero C and the portion from the latter to the end B, are preferably insulated from one another at the central zero.

The transistors used in the circuit must always be complementary, i.e., one of a PNP type and one of an NPN type, in order to generate a voltage substantially equal to 0 V on the connection between the bases of the transistors themselves.

With reference to FIG. 2, upon turning-on of the circuit, for example by closing of a switch S1, the first transistor T1 is activated whilst the second transistor T2 is inhibited. The current traverses the first transistor T1 and traverses the inductor L1, in the portion from the central zero C to the end B, until the load C1 is reached, which, behaving substantially as a capacitor, is charged until the maximum of the voltage envisaged is reached.

Once the load C1 has reached the maximum voltage envisaged, the current ceases to traverse the transistor T1 and the inductor L1.

At this point, the first transistor T1 goes into inhibition, and across the inductor L1 an opposite current is generated with respect to the initial one, which, however, is not sufficient to activate the second transistor T2. Thanks to the load C1, which has a positive voltage, a further opposite current is generated, which adds to the opposite current across the inductor L1 and enables activation of the second transistor T2, whilst the load C1 starts to discharge. In other words, the opposite current that traverses the second transistor T2 and the inductor L1, in the portion from the central zero C to the end A, activates the second transistor T2 itself.

After the load C1 has been completely discharged, the inductor L1 reverses the polarity, and the load C1, which functions as capacitor, recharges, thus activating the first transistor T1 and deactivating the second transistor T2 so as to restore the situation that existed initially at the moment of turning-on.

The cycle repeats until the circuit is deactivated, and during this cycle the load C1 remains constantly lit up.

According to a peculiar characteristic of the invention, the voltage with which the load C1 is supplied has a practically perfect sinusoidal waveform, substantially without any harmonics added to the carrier.

A second peculiar characteristic of the invention lies in the fact that, when the supply is removed or the load C1 is disconnected from the output of the circuit, the voltage on the connection between the bases of the two transistors T1 and T2 returns to a value of 0 V.

It should be noted that the operating frequency, i.e., the alternating current that supplies the load C1, is a function of the electrical characteristics of the load C1 and of the inductor L1, given that, as the capacitance of the load C1 and/or the inductance of the inductor L1 increase, the frequency decreases since the time necessary to reach the maximum voltage envisaged increases, and vice versa.

The capacitance of the electroluminescent cable is proportional to its length and diameter.

The capacitance of the electroluminescent panel is proportional to its dimensions.

The circuit is supplied in direct current, and only when the load C1, which functions as capacitor, is connected to the output of said circuit, does the inductor L1 start to oscillate, transforming the direct current into alternating current in the form of a substantially perfect sinusoidal signal, which supplies said load, which thus turns on. In other words, in connecting the load C1 to the output of the circuit, the circuit itself is closed, and the inductor L1 co-operates with the capacitor that is constituted by the load C1 itself.

From the experimental data it has surprisingly been found that, if the input of the circuit is connected to the electrical supply but there is no load C1 connected to the output of said circuit, the converter remains static: there is in fact no absorption or dispersion of electrical energy.

It should be noted that if passive components are added to the basic circuit described above, such as for example resistors, the circuit will no longer respect its characteristics of operation.

In addition to this, if for any external cause the temperature of the load C1 and/or of the inductor L1 exceeds a certain threshold, the converter is automatically deactivated. On the one hand, when the temperature of the load C1 exceeds a certain threshold, the load C1 itself no longer charges and is unable to originate a potential such as to generate an opposite current that is able to activate one of the two transistors T1 and T2, each of which remains in its current state. On the other hand, when the temperature of the inductor L1 exceeds a certain threshold, the opposite current decreases and it is no longer sufficient to switch one of the two transistors T1 and T2, even though there is the presence of the opposite current generated by the load C1.

The converter is automatically deactivated also in the case where there occurs a possible short circuit of the load C1 (electroluminescent cable or panel) so as to safeguard its supply source and its own components.

The same applies if a short-circuit of the direct-current source occurs.

The inventive idea underlying the invention enables provision of a converter for high and low powers limited by the technical characteristics alone of the components.

This innovative converter according to the present invention is preferably inserted in a closed container made of plastic material.

On the outside of the surface of the container there can be provided:
an on/off switch for activating said converter;
an output plug for supplying the load, such as, for example, a cable or a panel; and
an input plug for the electrical supply of the device itself.

As will emerge more clearly from what follows, it is possible to add other components to the basic circuit as illustrated in the drawings annexed hereto purely by way of example.

In a variant illustrated in FIG. 4, it is envisaged that the inductor L1 is wound on a ferrite core F to increase the inductance.

The circuit of said variant envisages as an alternative to the switch S1 two distinct pushbuttons: a first pushbutton Z1 for turning on the circuit, set between the base and the collector of the first transistor T1, and a second pushbutton Z2 for turning off the circuit, set between the emitter and the base of the first transistor T1 (FIG. 5).

In a second embodiment illustrated in FIG. 6, the output OUT2 of the circuit is taken between the second end B of the inductor L1 and the collector of the first transistor T1.

In a variant of the second embodiment, illustrated in FIG. 7, the inductor L1 is wound on a ferrite core F.

Also in this case, the circuit of said variant, as an alternative to the switch S1, can also envisage two distinct pushbuttons: a first pushbutton Z1 for turning on the circuit, set between the base and the collector of the first transistor T1, and a second pushbutton Z2 for turning off the circuit, set between the emitter and the base of the first transistor T1 (FIG. 8).

In a third embodiment illustrated in FIG. 9, the circuit has two outputs: a first output OUT1 set between the second end B of the inductor L1 and the collector of the second transistor T2, and a second output OUT2 set between the second end B of the inductor L1 and the collector of the first transistor T1.

Consequently, said circuit offers the possibility to the user of connecting a respective load to one or both of the outputs.

It should be pointed out that each of said loads must behave substantially as a capacitor.

In this specific case, the sinusoidal waveform generated by the circuit will supply the loads connected to the outputs.

In a variant of this third embodiment, illustrated in FIG. 10, the switch S1 is replaced by two distinct pushbuttons Z1 and Z2, respectively located between the base and the collector of the first transistor T1 and between the emitter and the base of the first transistor T1.

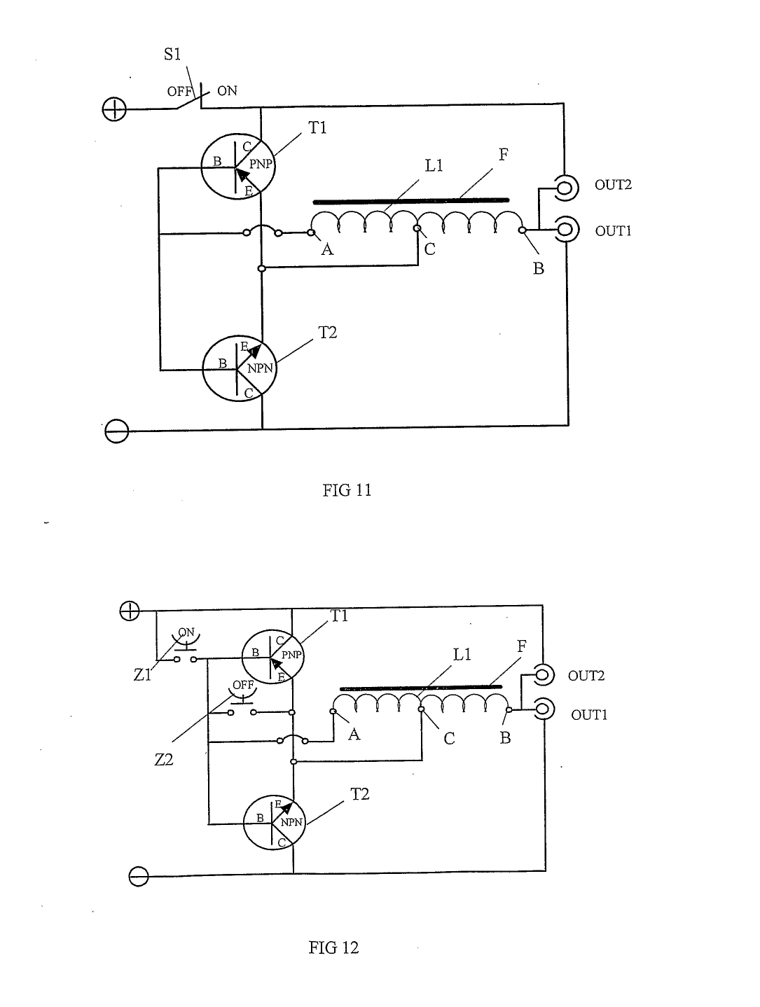

In a second variant of the third embodiment, illustrated in FIG. 11, it is envisaged that the inductor L1 is wound on a ferrite core F.

The circuit of said variant can also envisage, as an alternative to the switch S1, two distinct pushbuttons Z1 and Z2 as in the first variant (FIG. 12).

In a fourth embodiment illustrated in FIG. 13, the circuit comprises, instead of the inductor L1, two inductors that are the same as one another:
a first inductor L11 having a first end A that is to be connected to the bases of the two transistors T1 and T2, and a second end C11 that functions as central zero that is to be connected to the emitters of the two transistors T1 and T2; and
a second inductor L12 with a first end C12 that is free and a second end B that is to be connected to the, collector of the second transistor T2;
   wherein said circuit envisages an output OUT10 between said first end C12 of the second inductor L12 and the second end C11 of the first inductor L11.

A fifth embodiment illustrated in FIG. 14 differs from the preceding one in that the second end B of the second inductor L12 is connected to the collector of the first transistor T1.

A first variant of said fifth embodiment, illustrated in FIG. 15, envisages that said two inductors L11 and L12 are wound on a ferrite core F and that the switch S1 is replaced by two distinct pushbuttons Z1 and Z2, respectively, for turning on and turning off the circuit.

It is also possible to envisage that each of said inductors is each wound on a respective ferrite core (not illustrated in the figures).

In a sixth embodiment illustrated in FIG. 16, as an alternative to the inductor L1, two inductors are provided, each of which is wound on a corresponding portion of a ferrite ring AF: a first inductor V1 having a first end A connected to the bases of the two transistors T1 and T2 and a second end C, which, being connected to the emitters of the two transistors T1 and T2, functions as common central zero, and a second inductor V2 having a first end B that is free and a second end connected to the end C of the first inductor V1, i.e., to the central zero.

The circuit of said embodiment envisages at least one output for the connection of a load C1 and a switch S1 of a known type.

In the example described, the output designated by OUT1 is provided between said free end B of the second inductor V2 and the collector of the second transistor T2.

In other words, this sixth embodiment differs from the first embodiment in that the two portions of the inductor L1 are wound on two opposite sides of the ferrite ring AF.

In a variant illustrated in FIG. 17, the switch S1 is replaced by two distinct pushbuttons Z1 and Z2, respectively for turning on and turning off the circuit.

In a second variant illustrated in FIG. 18, the circuit envisages an inductor L3 wound on a ferrite core F set between the end B and the output OUT1.

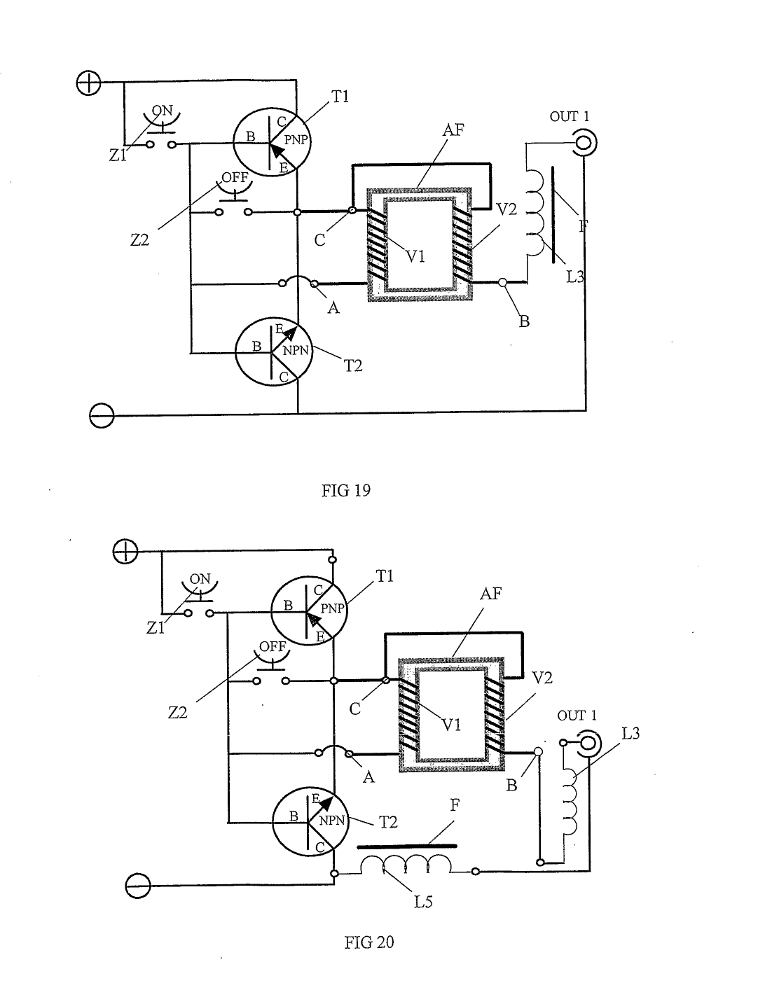

The circuit of said variant can envisage, as an alternative to the switch S1, two distinct pushbuttons Z1 and Z2, respectively for turning on and turning off the circuit (FIG. 19).

In a further, variant of the sixth embodiment, illustrated in FIG. 20, the circuit envisages an inductor L3 without ferrite core set between the end B and the output OUT1, and an inductor L5 wound on a ferrite core F set between the collector of the second transistor T2 and the output OUT1.

The circuit of a seventh embodiment envisages, unlike the circuit of the preceding embodiment, an output OUT2 between the free end B of the second inductor V2 and the collector of the first transistor T1 (FIG. 21).

In a first variant of said embodiment, the switch S1 is replaced by two distinct pushbuttons Z1 and Z2, respectively for turning on and turning off the circuit (FIG. 22).

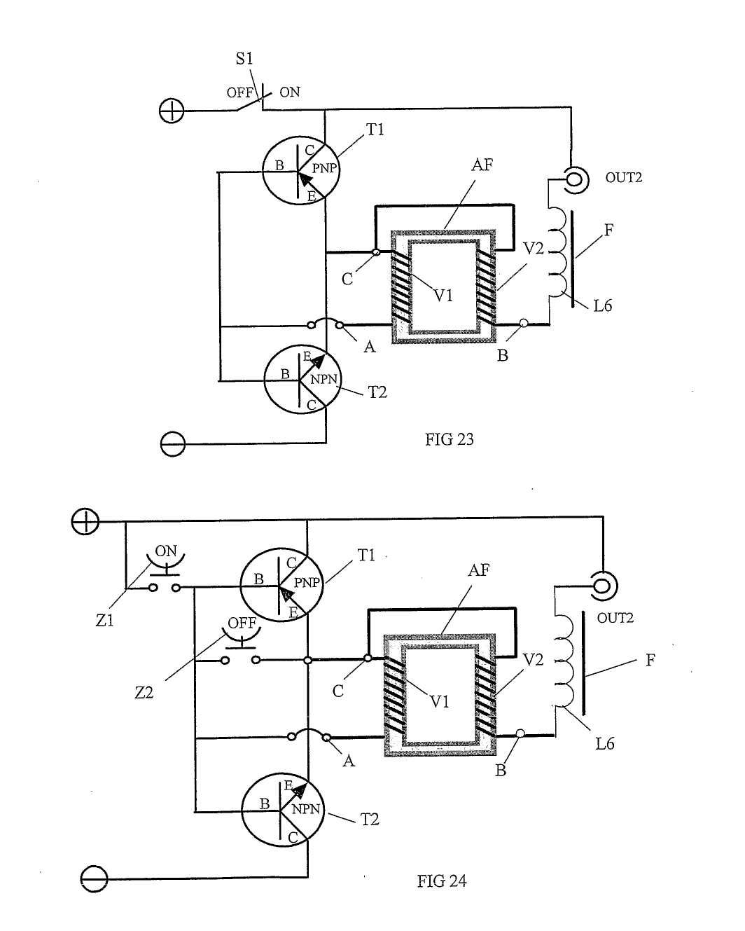

In a second variant, set between the free end B of the second inductor V2 and the output OUT2 is an inductor L6 wound on a ferrite core F (FIG. 23).

The circuit of said variant can envisage, as an alternative to the switch S1, two distinct pushbuttons Z1 and Z2, respectively for turning on and turning off the circuit (FIG. 24).

Said circuit can also be modified in such a way that the inductor L6 is without the ferrite core, and set between the collector of the first transistor T1 and the output OUT2 is an inductor L7 wound on a ferrite core F.

An eighth embodiment illustrated in FIG. 26 differs from the sixth embodiment in that a second output OUT2 is provided between the end B and the collector of the first transistor T1.

In a first variant illustrated in FIG. 27, the switch S1 is replaced by two distinct pushbuttons Z1 and Z2, respectively for turning on and turning off the circuit.

In a second variant illustrated in FIG. 28, the circuit envisages a first inductor L9 set between the end B and the output OUT1, a second inductor L10 wound on a ferrite core F set between the collector of the second transistor T2 and said output OUT1, and a third inductor L11, which is also wound on a ferrite core F, set between the collector of the first transistor T1 and the second output OUT2.

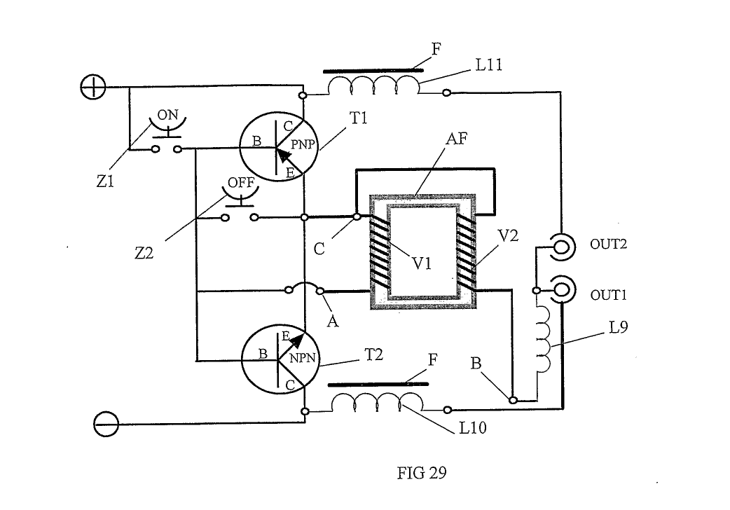

In a further variant illustrated in FIG. 29, the switch S1 is replaced by two distinct pushbuttons Z1 and Z2, respectively for turning on and turning off the circuit.

In the examples of embodiment described so far, it is advantageously possible to apply to the circuit a d.c. voltage that ranges from a minimum value of 0.050 mV up to a maximum value pre-set by the manufacturer.

Advantageously, as already mentioned, the circuit generates, starting from a direct current, an alternating current having a substantially perfect sinusoidal waveform that supplies a load having a behaviour similar to that of a capacitor, such as an electroluminescent cable or panel; said load in turn, thanks precisely to the fact that it is supplied by said waveform, has a brightness higher than the one that can be obtained with inverters of a known type with a consumption reduced by more than 50% as compared to that of known inverters.

As the electrical power that it is desired to supply to the electroluminescent cable or panel varies, the inventive idea underlying the invention does not change, but only the power levels and the dimensions of the components are modified as a function of the length of the cable or the dimensions of the panel.

The present invention has been described and illustrated in some preferred embodiments and variants thereof, but it is evident that the person skilled in the sector may make technically equivalent modifications and/or replacements thereto, without thereby departing from the sphere of protection of the present industrial patent right. For example, it is possible to envisage, as an alternative to the bipolar junction transistors (BJTs), as the ones used in the circuits described so far, transistors of a MOSFET or JFET type, provided that they are complementary to one another. It is also possible to envisage the addition of further pairs of complementary transistors to be connected in series or in parallel to the pair of transistors present in the circuit or also to envisage the addition of further inductors to be connected in series or in parallel to the inductor or inductors of the circuit.

What is claimed is:

1. A converter configured to transform direct current into alternating current, having a circuit, comprising:
a first transistor (T1) of a PNP (or else NPN) type, having a base and an emitter and a collector;
a second transistor (T2) of an NPN (or else PNP) type, having a collector, and a base and an emitter wherein said base and emitter are connected, respectively, to the base and to the emitter of the first transistor (T1);
a coil or inductor (L1) having a first end (A) connected to the bases of said two transistors (T1, T2), a second end (B) that is free, and a common central zero (C), which is connected to the emitters of the two transistors (T1, T2) and divides said inductor (L1) into two equal portions, a first portion from the end (A) to a central zero (C) and a second portion from the latter to the end (B);
wherein said circuit is supplied by a direct current applied to the collectors of the two transistors (T1, T2) and envisages at least one output (OUT1, OUT2), between said second end (B) and the collector of one of the two transistors (T1, T2), configured to supply a respective load (C1) that is configured to behave substantially as a capacitor or, an electroluminescent cable or panel;
wherein said transistors (T1, T2) work alternatively by following the cycles of charging and discharging of the load (C1); and,
thus obtain a supply current for said load (C1) having a substantially perfect sinusoidal waveform.

2. The converter according to claim 1, wherein the two portions of the inductor (L1) are insulated from one another at the central zero (C) itself or else are constituted by two distinct inductors (V1, V2) with the central zero (C) in common.

3. The converter according to claim 1, wherein, when the first transistor (T1) is active, it is traversed by a current that traverses the inductor (L1), in the second portion from the central zero (C) to the end (B), until the load (C1) is reached, which charges until it reaches the maximum of the voltage envisaged.

4. The converter according to claim 3 wherein, when the load (C1) has reached the maximum voltage envisaged, said current ceases to traverse the transistor (T1) and the inductor (L1), thus obtaining that the first transistor (T1) goes into inhibition and across the inductor (L1) there is generated a current opposite to the initial one.

5. The converter according to claim 4 wherein, when the load (C1) starts to discharge, a further opposite current is generated, which adds to the opposite current across the inductor (L1), thus obtaining that the second transistor (T2) is activated.

6. The converter according to claim 5, when the load (C1) is completely discharged, the inductor (L1) reverses the polarity, and the load (C1), which functions as capacitor, recharges, activating the first transistor (T1) and deactivating the second transistor (T2).

7. The converter according to claim 1, wherein the inductor (L1) is wound on a ferrite core (F).

8. The converter according to claim 1 wherein the output (OUT1) of the circuit is provided between the end (B) of the inductor (L1) and the collector of the second transistor (T2).

9. The converter according to claim 1 wherein the output (OUT2) of the circuit is provided between the end (B) of the inductor (L1) and the collector of the first transistor (T2).

10. The converter according to claim 1 wherein the circuit envisages two outputs: a first output (OUT1) between the end (B) of the inductor (L1) and the collector of the second transistor (T2), and a second output (OUT2) between the end (B) of the inductor (L1) and the collector of the first transistor (T2).

11. A converter configured to transform direct current into alternating current, comprising:
a first transistor (T1) of a PNP (or else NPN) type having a base and an emitter and a collector;
a second transistor (T2) of an NPN (or else PNP) type, having a collector, and a base and an emitter wherein said base and emitter are connected, respectively, to the base and to the emitter of the first transistor (T1);
a first inductor (L11) having a first end (A) connected to the bases of the two transistors (T1, T2) and a second end (C11) that functions as central zero and is to be connected to the emitters of the two transistors (T1, T2);
a second inductor (L12) with a first end (C12) that is free and a second end (B), that is to be connected to the collector of one of the two transistors;
wherein said circuit is supplied by a direct current applied to the collectors of the two transistors (T1, T2) and envisages at least one output (OUT10), between said first end (C12) of the second inductor (L12) and the second end (C11) of the first inductor (L11), configured to supply a respective load (C1) that is able to behave substantially as a capacitor, or an electroluminescent cable or panel,
wherein said transistors (T1, T2) work alternatively by following the cycles of charging and discharging of the load (C1); and,
thus obtain a supply current for said load (C1) having a substantially perfect sinusoidal waveform.

12. The converter according to claim 11 wherein said inductors (L11, L12) are wound on one and the same ferrite core (F) or on a corresponding ferrite core.

13. The converter according to claim 12, wherein each of the two inductors (V1, V2) is wound on a corresponding portion of a ferrite ring (AF): the first inductor (V1) has a first end (A), connected to the bases of the two transistors (T1, T2), and a second end (C), which, being connected to the emitters of the two transistors (T1, T2), functions as central zero, and the second inductor (V2) has one end connected to the end (C) of the first inductor (V1), and the second end (B) is free.

14. The converter according to claim 13 wherein said output (OUT1) is provided between said end (B) and the collector of the second transistor (T2).

15. The converter according to claim 14 wherein the circuit comprises an inductor (L3) wound on a ferrite core (F), configured to be set between the end (B) of the second inductor (V2) and said output (OUT 1).

16. The converter according to claim 14, wherein the circuit comprises an inductor (L3), designed to be set between the end (B) of the second inductor (V2) and said output (OUT1), and an inductor (L5) wound on a ferrite core (F), configured to be set between the collector of the second transistor (T2) and said output (OUT1).

17. The converter according to claim 13, wherein said output (OUT2) is provided between the free end (B) of the second inductor (V2) and the collector of the first transistor (T1).

18. The converter according to claim 17 wherein the circuit comprises an inductor (L6) wound on a ferrite core (F), designed to be set between the end (B) of the second inductor (V2) and said output (OUT2).

19. The converter according to claim 17, wherein the circuit comprises an inductor (L6), configured to be set between the end (B) of the second inductor (V2) and said output (OUT2), and an inductor (L7) wound on a ferrite core (F), designed to be set between the collector of the first transistor (T1) and said output (OUT2).

20. The converter according to claim 13, further comprising two outputs (OUT1, OUT2): a first output (OUT1) provided between the free end (B) of the second inductor (V2) and the collector of the second transistor (T2), and a second output (OUT2) provided between said free end (B) and the collector of the first transistor (T1).

21. The converter according to claim 20 wherein the circuit comprises an inductor (L9), configured to be set between the end (B) of the second inductor (V2) and said first output (OUT1), and an inductor (L10) wound on a ferrite core (F), designed to be set between the collector of the second transistor (T2) and said first output (OUT1), as well as an inductor (L11) wound on a ferrite core (F), designed to be set between the collector of the first transistor (T1) and said second output (OUT2).

22. The converter according to claim 11 wherein the circuit envisages a switch (S1) of a known type, set between the direct-current supply and the collector of one of the two transistors (T1, T2).

23. The converter according to claim 11 wherein the circuit envisages two distinct pushbuttons (Z1, Z2), respectively for turning on and turning off the circuit itself: a first pushbutton (Z1) set between the base and the collector of the first transistor (T1), and a second pushbutton (Z2) set between the emitter and the base of the first transistor (T1).
